(19) United States
(12) Patent Application Publication
(10) Pub. No.: US 2013/0173086 A1
(43) Pub. Date: Jul. 4, 2013

(54) TOWING DEVICE FOR MOTOR VEHICLES AND METHOD FOR TOWING A MOTOR VEHICLE

(71) Applicant: GM GLOBAL TECHNOLOGY OPERATIONS LLC, Detroit, MI (US)

(72) Inventor: Peter KAHLER, Nierstein (DE)

(73) Assignee: GM GLOBAL TECHNOLOGY OPERATIONS LLC, Detroit, MI (US)

(21) Appl. No.: 13/716,048

(22) Filed: Dec. 14, 2012

(30) Foreign Application Priority Data
Dec. 16, 2011 (DE) 102011121443.0

(51) Int. Cl. B60D 1/62

(52) U.S. Cl. CPC B60D 1/62
USPC 701/2; 280/422

(57) ABSTRACT

A towing device for motor vehicles is provided. The towing device includes a connecting unit for mechanically connecting a first vehicle to a second vehicle, and a data link between the first vehicle and the second vehicle. Control devices of the second vehicle can be accessed from the first vehicle via the data link.

### CROSS-REFERENCE TO RELATED APPLICATION

This application claims priority to German Patent Application No. 10 2011 121 443.0, filed Dec. 16, 2011, which is incorporated herein by reference in its entirety.

### TECHNICAL FIELD

The application pertains to a towing device for motor vehicles. It furthermore pertains to a method for towing a motor vehicle.

### BACKGROUND

DE 87 14 416 U1 discloses a towing device that simplifies towing a vehicle in that it features an intercom system, by means of which the driver of the towing vehicle and the driver of the vehicle being towed can communicate with one another. This is also intended, in particular, to improve the safety during the towing process.

Even if both vehicles can communicate with one another, towing a vehicle harbors numerous risks because the performance of both vehicles is changed due to their mechanical connection to one another. Consequently, towing a vehicle still is a risky process, particularly at inferior road conditions and/or with inexperienced drivers. In addition, significant forces are exerted on both vehicles during braking and accelerating maneuvers.

In addition, other objects, desirable features and characteristics will become apparent from the subsequent summary and detailed description, and the appended claims, taken in conjunction with the accompanying drawings and this background.

### SUMMARY

According to various aspects of the present disclosure, the present application provides a towing device for motor vehicles that ensures a high degree of safety during the towing process. It should be prevented, in particular, that the two vehicles participating in the towing process impair one another with respect to their performance. Furthermore, the towing process should be simplified for the drivers of the participating motor vehicles.

In this context and in the following description, towing a motor vehicle refers to the process, in which a typically inoperative or not completely operative motor vehicle is pulled by another vehicle, for example, as part of an emergency measure. However, it would basically also be possible to tow operative motor vehicles in this sense, for example, for transport purposes.

According to various aspects of the present disclosure, also provided is a particularly safe method for towing a motor vehicle.

According to one of various aspects of the present disclosure, a towing device for a motor vehicle that features a connecting unit for mechanically connecting a first vehicle to a second vehicle is proposed. The towing device furthermore features a data link between the first vehicle and the second vehicle, wherein control devices of the second vehicle can be accessed from the first vehicle via the data link.

In such a towing device, the connecting unit for mechanically connecting both vehicles to one another may be conventionally realized, for example, in the form of a cable, a rod or an axle. In addition, the towing device features a data link, by means of which data can be exchanged between the vehicles participating in the towing process.

The first, towing vehicle is able, in one example, to access control devices of the second vehicle being towed. Consequently, it is possible to carry out interventions on the second vehicle such as, for example, braking or steering interventions in order to positively influence the performance of the entire ensemble.

In this case, the data link primarily makes it possible to analyze the state of the vehicle being towed from the towing vehicle. When towing a defective vehicle, in one example, the type of defect can be transmitted to the towing vehicle and the performance of the towing vehicle can be adapted accordingly. Since modern motor vehicles feature diagnostic systems, the corresponding information to be transmitted to the towing vehicle is available anyhow and can be easily read out.

The data link furthermore makes it possible to directly access control devices of the vehicle being towed such that the performance of the vehicle being towed can thusly be influenced.

In the case of braking maneuvers, the vehicle being towed may be prompted, for example, to initiate its own braking maneuver in that the towing vehicle accesses the brake control of the vehicle being towed. This improves the safety of the braking maneuver because the vehicle being towed also generates a braking force. Furthermore, the driver of the vehicle being towed does not have to estimate the required braking force himself, wherein this estimation is frequently quite complicated during a towing process.

In the case of acceleration maneuvers, it may be desirable that the vehicle being towed also accelerates and/or that the towing vehicle accelerates in a particularly gentle fashion and takes into consideration the presence of the vehicle being towed during its acceleration.

This not only makes it possible to improve the safety during braking and accelerating maneuvers, but also to reduce the forces acting upon the participating vehicles.

In the case of inferior road conditions, the towing vehicle can access an ESC system or another advanced driver assistance system of the vehicle being towed. The advanced driver assistance systems of both vehicles participating in the towing process may cooperate with one another, in one example, in order to avoid accidents.

The information exchanged via the data link can also be used for setting and enforcing speed limits or for outputting warnings or suggestions for the participating drivers.

In this context, it would be conceivable to eliminate the need for a driver in the vehicle being towed. The performance of the vehicle being towed is in this case controlled entirely from the towing vehicle, wherein the control devices of the vehicle being towed are accessed in the required fashion. Consequently, the entire towing process can be carried out by a single person.

According to one exemplary embodiment, the data link is realized in a wire-bound fashion. In this case, the data link may be integrated into the connecting unit. In this context, a data link that is integrated into the connecting unit refers to an arrangement, in which the data link is structurally connected to the connecting unit such as, for example, accommodated in a cavity of the connecting unit provided for this purpose.

In another exemplary embodiment, the data link is realized in a wireless fashion such as, for example, in the form of a Bluetooth or WLAN connection.

According to an exemplary embodiment, it is proposed that a steering control of the second vehicle can be accessed via the data link.

According to another exemplary embodiment, it is proposed that the brake control of the second vehicle can be accessed via the data link.

According to another exemplary embodiment, it is proposed that an engine control of the second vehicle can be accessed via the data link.

It would also be conceivable to realize corresponding combinations, in which interventions are carried out on several control devices. In this case, the first vehicle is able to activate, for example, advanced driver assistance systems of the second vehicle such as the ESC, the antilock braking system, the traction control system or the electronic braking force distribution system.

According to one of various aspects of the present disclosure, the described towing device is used for towing a motor vehicle.

According to another aspect of the present disclosure, a method for towing a motor vehicle is proposed, wherein a first, towing vehicle is mechanically connected to a second vehicle being towed by means of a connecting unit, and wherein control devices of the second vehicle are accessed from the first vehicle via a data link during the towing process.

According to an exemplary embodiment, a steering control of the second vehicle is accessed.

According to another exemplary embodiment, a brake control of the second vehicle is accessed.

According to another exemplary embodiment, an engine control of the second vehicle is accessed.

According to another exemplary embodiment, information on the state of the second vehicle is transmitted to an advanced driver assistance system of the first vehicle.

Such information may concern, in one example, the state of the vehicle being towed, i.e., the type of defect when towing a defective vehicle.

According to another exemplary embodiment, information on the state of the second vehicle is transmitted to a navigation system of the first vehicle. Such information may likewise concern the type of defect of the second vehicle, but also merely the presence thereof. In the latter instance, the navigation system can register the towing process and select a route that is particularly suitable for the towing process, for example, because it contains only few uphill sections, traffic jams, intersections or traffic lights.

In this case, the navigation system takes into consideration the received information on the state of the second vehicle during the navigation.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 schematically shows two vehicles participating in a towing process by means of a towing device according to an exemplary embodiment of the present disclosure;

FIG. 2 schematically shows a cross section through a towing device according to another exemplary embodiment of the present disclosure, and

FIG. 3 schematically shows a cross section through a towing device according to another exemplary embodiment of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

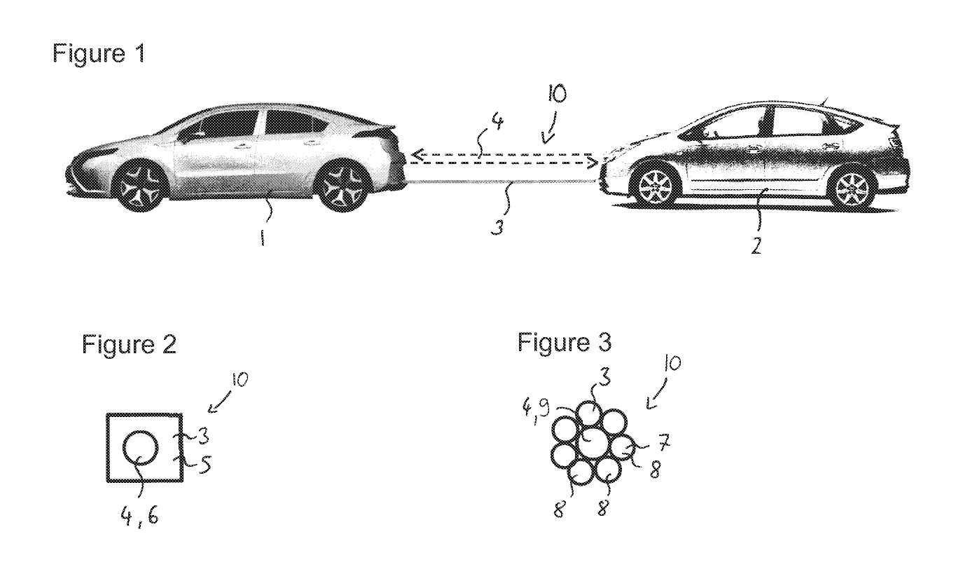

FIG. 1 schematically shows a towing process, in which a first vehicle 1 tows a second vehicle 2. The first vehicle 1 is connected to the second vehicle 2 by means of a towing device 10.

The towing device 10 comprises a connecting unit 3 for mechanically connecting the first vehicle 1 to the second vehicle 2. It furthermore comprises a bidirectional data link 4 that is realized in a wireless fashion in the exemplary embodiment illustrated in FIG. 1.

Information can be exchanged between the vehicles 1, 2 prior to and during the towing process via the data link 4. The first vehicle 1 is able, in one example, to access not-shown control devices of the second vehicle 2 and therefore to influence and adapt the performance of the second vehicle 2 to the towing process.

FIG. 2 schematically shows a cross section through a towing device 10 according to another exemplary embodiment of the present disclosure.

In this exemplary embodiment, the towing device 10 features a rod 5 that forms the connecting unit 3 for mechanically connecting the two vehicles 1, 2 to one another.

In this exemplary embodiment, the data link 4 is not realized in a wireless fashion, but rather in the form of a data cable 6. The data cable 6 is routed in the interior of the rod 5 and therefore integrated therein.

FIG. 3 schematically shows a cross section through a towing device 10 according to another exemplary embodiment of the present disclosure.

In this exemplary embodiment, the towing device 10 features a cable 7 that is composed of individual strands 8 and forms the connecting unit 3 for mechanically connecting the two vehicles 1, 2 to one another.

In this exemplary embodiment, the data link 4 likewise is not realized in a wireless fashion, but rather in the form of a data cable 9. The data cable 9 is routed in the interior of the cable 7 and surrounded by individual strands 8. It is therefore integrated into the cable 7.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A towing device for motor vehicles, comprising:
a connecting unit for mechanically connecting a first vehicle to a second vehicle; and
a data link between the first vehicle and the second vehicle,
wherein control devices of the second vehicle are accessible from the first vehicle via the data link.

2. The towing device according to claim 1, wherein the data link is realized in a wire-bound fashion.

3. The towing device according to claim 2, wherein the data link is integrated into the connecting unit.

4. The towing device according to claim 1, wherein the data link is realized in a wireless fashion.

5. The towing device according to claim 1, wherein a steering control of the second vehicle is accessible via the data link.

6. The towing device according to claim 1, wherein a brake control of the second vehicle is accessible via the data link.

7. The towing device according to claim 1, wherein an engine control of the second vehicle is accessible via the data link.

8. A first motor vehicle, comprising:
a towing device for towing a second motor vehicle, the towing device including a connecting unit for mechanically connecting the first motor vehicle to the second motor vehicle and a data link between the first vehicle and the second vehicle,
wherein control devices of the second motor vehicle are accessible from the first motor vehicle via the data link, the control devices selected from a group comprising: a steering control, a brake control and an engine control.

9. A method for towing a motor vehicle, comprising:
mechanically connecting a first, towing vehicle to a second vehicle being towed by means of a connecting unit; and
accessing control devices of the second vehicle from the first vehicle via a data link during the towing process.

10. The method according to claim 9, further comprising:
accessing a steering control of the second vehicle.

11. The method according to claim 9, further comprising:
accessing a brake control of the second vehicle.

12. The method according to claim 9, further comprising:
accessing an engine control of the second vehicle.

13. The method according to claim 9, further comprising:
transmitting information on a state of the second vehicle to an advanced driver assistance system of the first vehicle.

14. The method according to claim 9, further comprising:
transmitting information on the state of the second vehicle to a navigation system of the first vehicle.

15. The method according to claim 14, wherein the navigation system takes into consideration the received information on the state of the second vehicle during the navigation.
